(19) United States
(12) Patent Application Publication
(10) Pub. No.: US 2005/0062361 A1
(43) Pub. Date: Mar. 24, 2005

(54) Stepping electrostatic comb drive actuator

(76) Inventors: Jonah A. Harley, Mountain View, CA (US); Storrs T. Hoen, Brisbane, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/664,947

(22) Filed: Sep. 22, 2003

(51) Int. Cl. H02N 1/00

(52) U.S. Cl. 310/309

(57) ABSTRACT

An electrostatic stepping comb drive actuator has a first tooth and a second tooth. Each tooth has a first surface, with the first surface of the first tooth opposite the first surface of the second tooth, first conductors, and a first electrode array located on the first surfaces. The first electrode array includes first electrodes in first electrode groups. The comb drive actuator further includes a second member having a third tooth interdigitated with the first tooth and the second tooth such that relative motion is possible between the third tooth and the first and second teeth. The third tooth includes a second surface disposed opposite each of the first surfaces, second conductors, and a second electrode array located on the second surfaces. The second electrode array includes second electrodes in second electrode groups. The second electrodes in each second electrode group are electrically connected to the same one of the second conductors.

### TECHNICAL FIELD

The technical field is electrostatic actuators, and more particularly micro-machined electrostatic comb drive actuators.

### BACKGROUND

Microelectromechanical systems (MEMS) often use electrostatic actuators to impart motion for the purpose of positioning optical devices and switches, and for turning gears, for example. Such electrostatic actuators are particularly useful for applications with low to moderate force requirements. For some of these applications, the electrostatic actuators should have a large travel, should be positioned with great precision, and should operate in response to a low actuation voltage.

One application of an electrostatic actuator is to tilt a micro-machined mirror, which may be on the order of several hundred μm in diameter. Such a mirror may be used in optical cross-connect switches, tunable lasers, micro-displays and scanning vision systems, for example. A current electrostatic actuator that could be used to tilt the mirror is a parallel plate electrostatic actuator. As the name implies, the parallel plate electrostatic actuator comprises two parallel plates, one of which is allowed to pivot about a central point. The two parallel plates are initially separated by a gap. In practical applications, the moveable (pivoting) plate can only move about ⅓ of the initial gap before the actuator becomes unstable. Furthermore, in parallel plate actuators, force scales as the inverse square of the distance between the plates, making this actuator highly non-linear and difficult to control. These and other limitations make parallel plate actuators undesirable for many applications. Another current design for an electrostatic actuator is the comb drive actuator, the name derived from the actuator's dominant physical structure, namely its resemblance to a comb. Comb drive actuators have a stationary element and a movable element, which moves relative to the stator. The stationary element will be referred to hereafter as a stator, and the moveable element will be referred to hereafter as a rotor. However, use of the term “rotor” is not meant to imply rotational motion between the stator and the rotor, and in a common application of a comb drive actuator, the rotor moves linearly in a plane parallel to a plane occupied by the stator. The stator and the rotor each have one or more teeth. In a typical application, the comb drive actuator may have many stages of stator and rotor teeth. A section of a simplified comb drive actuator 100 is shown in perspective view in FIG. 1.

The section of the electrostatic comb drive actuator 100 includes a rotor 110 having rotor teeth 111 and a stator 120 having stator tooth 121 that is engaged with the rotor teeth 111 (i.e., that partially overlaps, or is interdigitated, with the rotor teeth 111 in the x-direction). The rotor teeth 111 and the stator tooth 121 include conductors by means of which a voltage difference is applied from voltage source 130 to the comb drive actuator 100 to induce axial (x-direction) motion. During operation, the rotor 110 may be grounded, and the stator 120 may have a bias voltage V applied. Application of the bias voltage V creates electrical fields between the teeth 111, 121. The electrical fields cause the x-direction motion of the rotor 110.

The comb drive actuator 100 may include a suspension (not shown) that is compliant in the direction of desired displacement (i.e., the x-direction), but is stiff in directions orthogonal to the x-direction. This relationship between compliance in the x-direction, and stiffness in the y- and z-directions may be expressed as a ratio of spring constants. Current comb drive actuators, such as the comb drive actuator 100 shown in FIG. 1, suffer from several shortcomings. These include limited x-direction travel due to side instability, unilateral forces, and difficulty in precisely controlling x-direction motion. When a voltage difference is applied between the stator and the rotor, lateral electrostatic forces (i.e., in the y-direction), as well as axial (i.e., in the x-direction) are created. The lateral electrostatic forces act on each side of the rotor, and normally cancel each other, resulting in no deflection of the rotor in the y-direction. However, when the first derivative of the electrostatic force in the y-direction becomes larger than the restoring spring constant in the y-direction, a side instability will exist in the comb drive actuator. This instability is a function of the applied voltage, the gap between the rotor teeth and the stator teeth, and the lateral spring constant. This lateral spring constant may in turn be a function of the x-direction displacement such that the lateral instability limits the overall x-direction travel.

Current, practical comb drive actuators typically require between 10 and 200 teeth to generate enough force for a MEMS device. Such a comb drive actuator may have a range of motion equal to the x-direction dimension of the teeth, which can be greater than 100 μm, but is typically limited by electromechanical side instability to 10-20 μm. When the lateral spring constant value is exceeded, the rotor teeth will move rapidly to the side (i.e., the y-direction), and may contact the stator teeth. Such contact will short the electrodes and disrupt the x-direction motion of the rotor.

Another shortcoming of current comb drive actuators is that they apply the motive force in only one direction (e.g., the +x-direction) since the rotor and stator teeth only have the ability to attract one another, not to repel each other. Hence, current comb drive actuators use mechanical springs to provide a restoring force. If push-pull actuation is required, two sets of comb teeth are required.

Yet another shortcoming of current comb dive actuators is that they provide analog positioning in which the positioning varies continuously with the applied voltage. Accurate positioning of such a current comb drive actuator requires that the voltage be controlled with high precision.

### SUMMARY

In one aspect, what is disclosed is an electrostatic stepping comb drive actuator that has a first tooth and a second tooth. Each of the first and second teeth has a first surface, with the first surface of the first tooth opposite the first surface of the second tooth, first conductors, and a first electrode array located on the first surfaces. The first electrode array includes first electrodes in first electrode groups. The first electrodes in each of the first electrode groups electrically connected to a same one of the first conductors. The stepping comb drive actuator further includes a second member, which includes a third tooth interdigitated with the first tooth and the second tooth such that relative motion in a direction of travel is possible between the third tooth and the first and second teeth. The third tooth includes a second surface disposed opposite each of the first surfaces, second conductors, and a second electrode array located on the second surfaces. The second electrode array includes second electrodes in second electrode groups. The second electrodes in each second electrode group electrically connected to the same one of the second conductors.

In another aspect, what is disclosed is an electrostatic stepping comb drive actuator that includes a stationary member having a tooth, where the tooth includes opposed surfaces, and a first electrode array disposed on the first surfaces, a first conductor coupled to the first electrode array, a moveable member having second electrode arrays disposed on surfaces opposite the first surfaces, and second conductors electrically connected to the second electrode arrays.

In yet another aspect, what is disclosed is an electrostatic comb drive actuator that has a tooth, where the tooth includes opposed first surfaces, and a first electrode array located on the first surfaces. The first electrode array includes first electrodes. The comb drive actuator further includes an interconnected pair of coupled teeth. The interconnected pair of coupled teeth has second surfaces opposite the first surfaces, and second electrode arrays located on the second surfaces. The second electrode arrays comprising second electrodes.

### DESCRIPTION OF THE DRAWINGS

The detailed description will refer to the following drawing figures in which like numbers refer to like elements, and in which:

FIG. 1 is a perspective view of a section of a prior art electrostatic comb drive actuator;

FIG. 2 is a perspective view of an embodiment of a section of a stepping electrostatic comb drive actuator that includes a stator tooth and two rotor teeth; and

FIGS. 3A-3F are plan and side views of a rotor section and a stator section of the stepping electrostatic comb drive actuator of FIG. 2;

FIG. 3G is a plan view of the stepping electrostatic comb drive actuator in a folded-beam flexure suspension;

FIG. 4 illustrates an alternating voltage pattern used by the stepping electrostatic comb drive actuator of FIG. 2;

FIG. 5 illustrates x-direction force generation by the stepping electrostatic comb drive actuator of FIG. 2; and

FIG. 6 is a flowchart illustrating an embodiment of a method for forming the electrostatic comb drive actuator of FIG. 2.

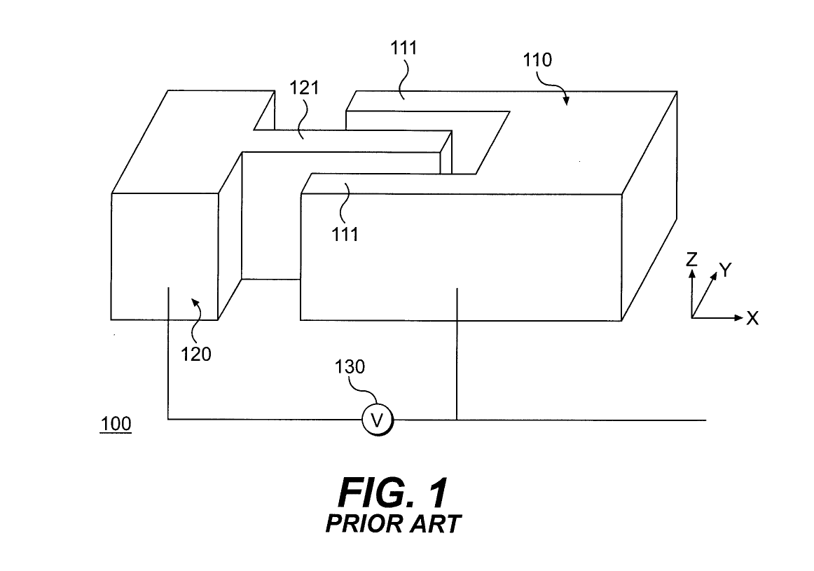

### DETAILED DESCRIPTION

Micro-machined drive actuators ideally operate with low applied voltages, provide significant axial travel without instabilities, operate bi-directionally, allow for precise positioning, and are simple and inexpensive to manufacture.

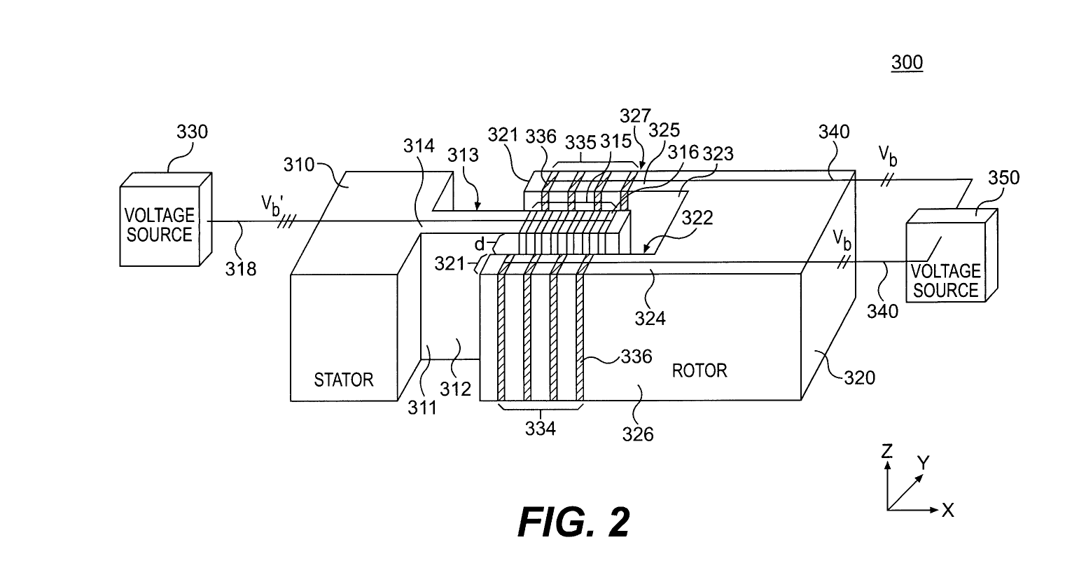

FIG. 2 is a perspective view of an embodiment of a section of a stepping electrostatic comb drive actuator 300 in accordance with the invention. The example shown is formed using micro-machining techniques. Only a section is shown for clarity and ease of illustration. The actuator 300 may comprise many sections of stator and rotor teeth. In an embodiment, the actuator 300 includes tens or hundreds of such sections, for example. The actuator 300 additionally includes a suspension, also not shown, which is compliant in the direction of motion (the x-direction) and stiff in directions orthogonal to the direction of motion.

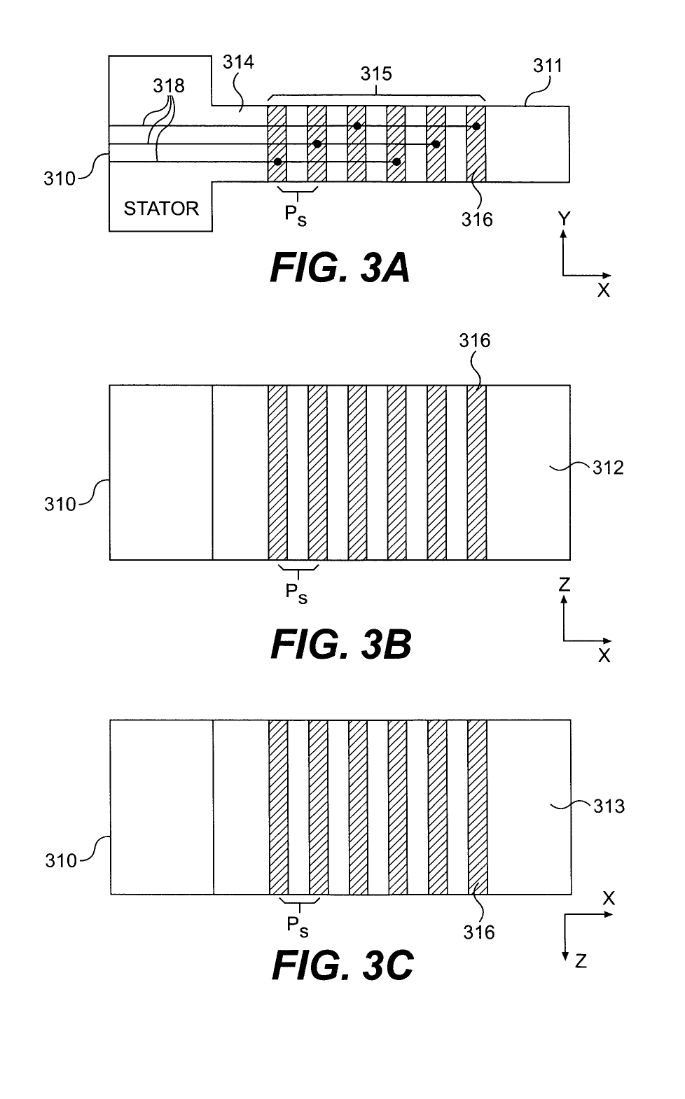

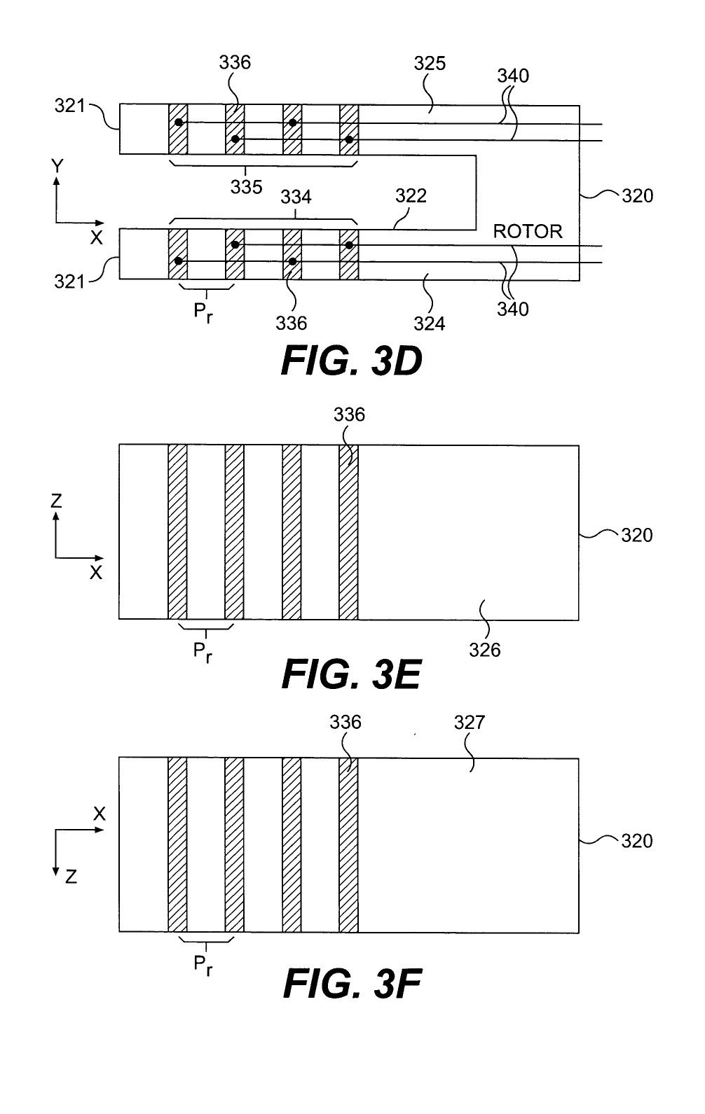

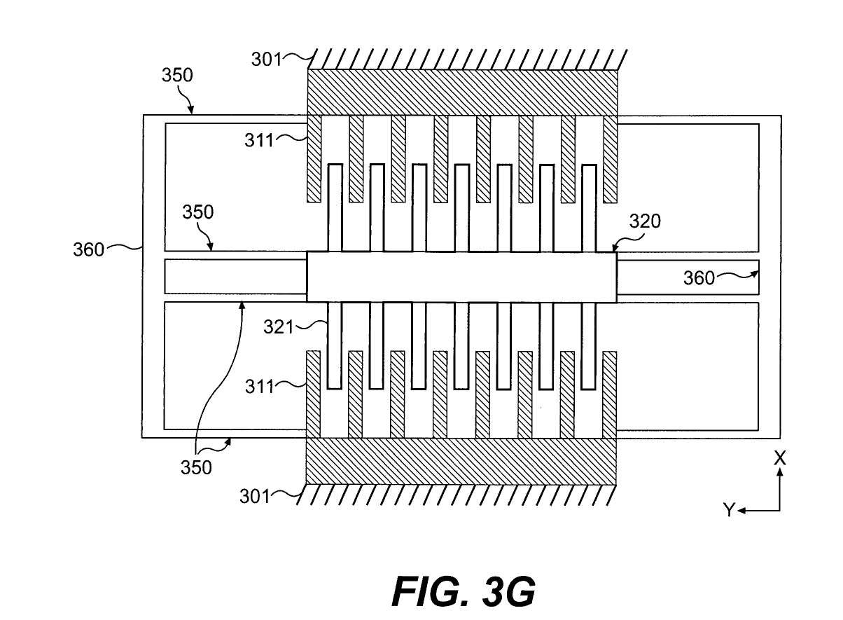

FIGS. 3A-3F are plan and side views of a stator and a rotor of the section of the comb drive actuator 300 shown in perspective view in FIG. 2. For clarity, the stator is shown in FIGS. 3A-3C and the rotor is shown in FIGS. 3D-3F.

As can be seen in FIG. 2, the illustrated section of the actuator 300 has a stator 310 that includes a single stator tooth 311. The stator 310 is stationary. The section of the actuator 300 also includes a rotor 320, which is capable of moving. Although element 320 is called a “rotor,” the rotor 320 does not necessarily move rotationally, and, in fact, the rotor 320 illustrated in FIG. 2 moves in a generally straight line in the x-direction. The rotor 320 includes two rotor teeth 321. The stator tooth 311 and the rotor teeth 321 are separated by gap d.

The stator tooth 311 includes plane opposed surfaces 312 and 313 (plane surface 313 is not visible in the perspective view of FIG. 2—see FIG. 3C) and plane surface 314, upon which are located an array 315 of stator electrodes. For ease of illustration, the electrode array 315 is shown with six stator electrodes 316. However, in an actual application, the electrode array 315 may have many more stator electrodes 316. Each of the stator electrodes 316 is electrically isolated from the plane surfaces 312, 313, 314. As shown, each stator electrode 316 is oriented in the z-direction on the plane opposed surfaces 312, 313, and in the y-direction on the plane surface 314. On the plane surface 314, each of the stator electrodes 316 is in electrical contact with one of three conductors 318 (see FIG. 3A). The conductors 318 are supplied with a voltage V_{b}′ from voltage source 330. The stator electrodes 316 are electrically connected to the voltage source 330 so that the stator electrodes 316 in the electrode array 315 are biased in groups, with each group receiving the same or a different driving voltage V_{b}′. In an example illustrated in FIG. 3A, the stator electrodes 316 are grouped into two groups with three electrodes 316 per group. Each of the stator electrodes 316 in a group of stator electrodes is supplied with a same voltage, such as high, low, or some percentage of high.

As shown in FIG. 3A, the center of each stator electrode 316 in the electrode array 315 is separated from the center of adjacent stator electrodes 316 by a distance pₛ. The distance pₛ is termed the stator electrode pitch. The stator electrode pitch p, may be constant among the stator electrodes 316. Alternatively, the stator electrode pitch pₛ may vary among the stator electrodes 316.

Returning to FIG. 2, similar to the tooth 311 on the stator 310, the rotor teeth 321 include plane opposed interior surfaces 322 (not visible in the perspective view of FIG. 2—see FIG. 3D) and 323 disposed opposite the plane surfaces 312, 313, respectively of the stator tooth 311. The rotor teeth additionally include plane surfaces 324 and 325 and plane exterior surfaces 326 and 327 (surface 327 is not visible in the perspective view of FIG. 2—see FIG. 3F). Formed on the plane surfaces 322, 324, and 326 is electrode array 334. Formed on the plane surfaces 323, 325, and 327 is electrode array 335. The electrode arrays 334 and 335 include individual rotor electrodes 336, each of which is electrically isolated from its respective plane surfaces 322-327. The center of each rotor electrode 336 is separated from the centers of adjacent rotor electrodes 336 by a distance pᵣ, termed the rotor electrode pitch.

For ease of illustration, the electrode arrays 334 and 335 are shown with four rotor electrodes 336. However, in an actual application, the electrode arrays 334 and 335 typically contain many more rotor electrodes. Furthermore, on a unit distance basis, the number of rotor electrodes 336 may be less than or greater than the number of stator electrodes 316. In an embodiment, over a given distance in the x-direction on the rotor 320 and the stator 310 there are three stator electrodes 316 for every two rotor electrodes 336 in each of the electrode arrays 324 and 325. In this embodiment,

$${p}_{s} = \frac{2}{3} {p}_{r} .$$

In an alternative embodiment, over the given distance there are five stator electrodes 316 for every four rotor electrodes 336 in each of the electrode arrays 324 and 325, and

$${p}_{s} = \frac{4}{5} {p}_{r} .$$

Other ratios of stator electrodes 316 to rotor electrodes 336 over the given distance are also possible. As will be described below, the ratio of the electrode pitches, pₛ/pᵣ, determines the x-direction travel of the rotor 320 when a spatially alternating voltage pattern imposed on the comb drive actuator 300 is changed.

Referring to FIG. 3D, conductors 340 are formed on the rotor 320 and extend over the plane surfaces 326 and 327 to contact the rotor electrodes 336. To maintain a fixed rotor position, or when movement of the rotor 320 is desired, the conductors 340 are used to apply a high voltage V_{b} from voltage source 350 (see FIG. 2) to every other rotor electrode 336 and a low voltage V_{b} (usually ground) to the remaining rotor electrodes 336. In an alternative embodiment, every other rotor electrode 336 is supplied with an intermediate voltage V_{b} and the remaining rotor electrodes 336 are supplied with a low voltage V_{b}.

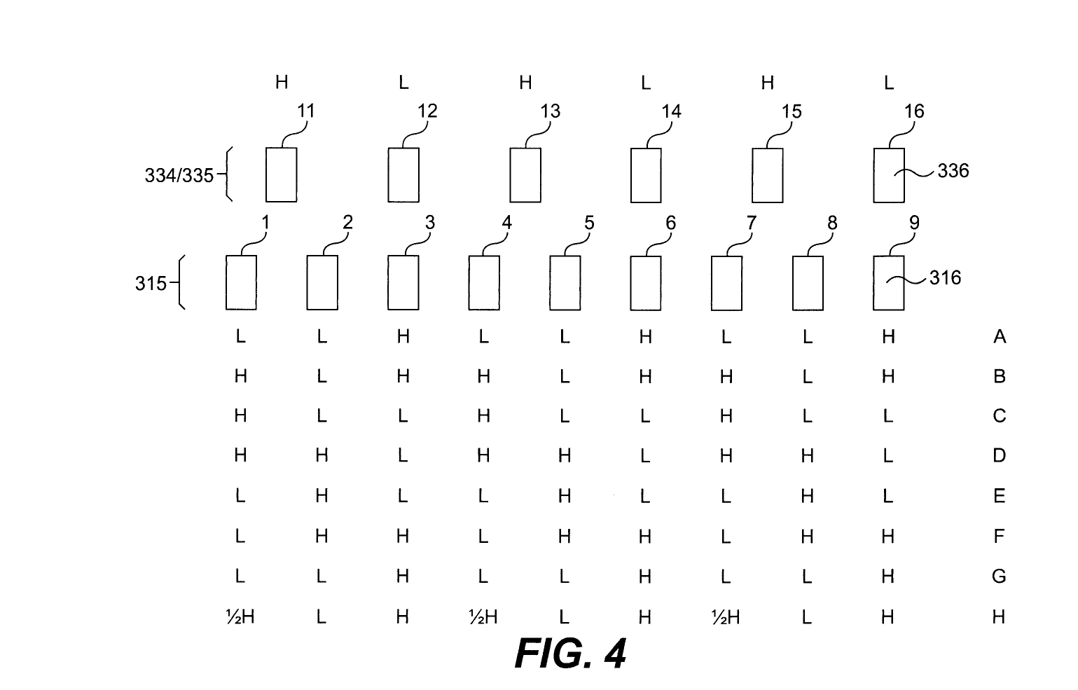

As illustrated by the embodiment of the stator 310 shown in FIG. 3A, each of three stator conductors 318 is electrically connected to every third stator electrode 316 in the electrode array 315. Using the conductors 318, a high voltage V_{b}′ is applied to selected stator electrodes 316, and a low voltage V_{b}′ (usually ground) is applied to the remaining stator electrodes 316. As described below with reference to FIG. 4, the application of high and low voltages V_{b}′ creates a spatially substantially alternating voltage pattern on the stator 310. Changing the spatially substantially alternating voltage pattern on the stator 310 causes the rotor 320 to translate in discrete, precisely controllable steps in the +x- and −x-directions.

FIG. 3G is a plan view of a stepping comb drive actuator showing the rotor 320 supported in a folded-beam flexure suspension. The stator 310 is anchored to substrate 301. The folded-beam flexure suspension is well known in the art and includes rigid beams 360 disposed in the x-direction and flexures 350 that extend in the y-direction, from the rotor 320 to one of the beams 360, and from one of the beams 360 to the stator 310. The folded-beam flexure suspension is compliant in the x-direction and is stiff in directions orthogonal to the x-direction.

FIG. 4 illustrates a spatially substantially alternating voltage pattern that is established on the opposed surfaces 312, 313 of the stator 310 by the electrode array 315, the stator electrodes 316, and the voltage source 320 in an example in which the stator electrodes 316 have a constant pitch pₛ. In the illustrated example, the electrode array 315 includes nine stator electrodes (316) 1-9, grouped in groupₛ of three, and the electrode arrays 334 and 335 of the rotor 320 are each composed of six rotor electrodes (336) 11-16. The stator electrodes (316) 1-9 may have a voltage fixed at low (L) or high (H), and may also have voltages intermediate between low (L) and high (H).

The voltage states of the rotor electrodes (336) 11-16 typically are fixed at either high (H) or low (L), but may also have intermediate voltages between high (H) and low (L). In the example illustrated in FIG. 4, every other rotor electrode 336 is high (H) and the remaining rotor electrodes 336 are low (L), resulting in a spatially alternating voltage pattern.

In a typical stepping pattern, the voltage states of the stator electrodes (316) 1-9 are varied as shown through steps A-G to move the rotor 320. The initial state of the spatially substantially alternating voltage pattern is shown at A, where a phase flip, or local disruption, occurs every three stator electrodes 316. Lateral displacement of the rotor 320 along the +x-direction is achieved by sequentially moving the local disruption to the spatially substantially alternating voltage pattern on the electrode array 315. Such a sequential shift in the local disruption is shown at B, where the voltage at the group of three stator electrodes 1, 4, and 7 is changed from low (L) to high (H). Such a change in the spatially substantially alternating voltage pattern moves the rotor 320 in the +x-direction by ⅓ of pᵣ, where pᵣ is the rotor electrode pitch. A further change in the position of the local disruption in the spatially substantially alternating voltage pattern is illustrated at C, where the voltage at the group of three stator electrodes 3, 6, and 9 is shifted from high (H) to low (L). Such a change in the spatially substantially alternating voltage pattern moves the rotor 320 further in the +x-direction. D-G show the spatially substantially alternating voltage pattern as the local disruption completes the sequence and returns to the spatially substantially alternating voltage pattern condition originally shown at A. During each of the spatially substantially alternating voltage patterns shown at D-G, the rotor 320 moves in the +x-direction. H shows a different change in the spatially substantially alternating voltage pattern, where the voltage at the group of three stator electrodes 1, 4, and 7 is shifted from high (H) to ½ high (½H). This change in the spatially substantially alternating voltage pattern moves the rotor 320 in the +x-direction; however, the rotor movement as a consequence of H is one-half that of G. That is, as a result of the spatially substantially alternating voltage pattern illustrated at H, the rotor 320 moves in the +x-direction by ⅙ of pᵣ. Further changes in the spatially substantially alternating voltage pattern on the electrode array 315 may cause further +x-direction movement of the rotor 320. In addition, the rotor 320 may be moved in the −x-direction by appropriately changing the spatially substantially alternating voltage pattern on the electrode array 315.

The forces and force gradients that can be generated in the stepping comb drive actuator 300 illustrated in FIG. 2 can be expressed using standard Fourier transforms. For example, considering the first term in a Fourier approximation of the voltage patterns applied to the stator 310 and the rotor 320, the x-direction force F(x)_{SCD} per volt squared per unit area of a single stator tooth in the stepping comb drive actuator 300 is given by:

$${F ( x )}_{SCD} = \frac{{c}_{e} {ɛ}_{0}}{{p}_{r}^{2}} \frac{sin ( \frac{π x}{{p}_{r}} )}{sinh ( \frac{π d}{{p}_{r}} )} , \qquad ( Eq . 1 )$$

where pᵣ is the rotor electrode pitch, x is the x-direction displacement of the rotor teeth 321 relative to the stator tooth 311, ε₀ is a dielectric constant, and d is the gap between the rotor teeth 321 and the stator tooth 311. In Equation 1, the coefficient cₑ is given by

$${c}_{e} = \frac{{π}^{2}}{2} \vert {\int }_{0}^{L} {ϕ}_{R} ( x ) {ⅇ}^{- \frac{ⅈ π x}{{p}_{r}}} ⅆ x \vert \cdot \vert {\int }_{0}^{L} {ϕ}_{S} ( x ) {ⅇ}^{- \frac{ⅈ π x}{{p}_{r}}} ⅆ x \vert , \qquad ( Eq . 2 )$$

where φ_{R}(x) and φ_{S}(x) are normalized voltage potentials on the rotor tooth surface (322, 323 in FIG. 2) and stator tooth surface (312, 313 in FIG. 2), respectively. The voltage potentials are normalized with respect to the maximum applied voltage. L is the distance over which both the stator potential and rotor potential is periodic. In the case where pₛ is ⅔rds pᵣ, L is 2pᵣ, or equivalently 3pₛ.

The coefficient cₑ generally varies between I and a maximum of 2. When the stator electrode pitch is ⅔rds of the rotor electrode pitch, the space between the electrodes is equal to the electrode width, and the voltage patterns correspond to those shown in FIG. 4, cₑ is 1.489. For a comparable situation with a stator electrode pitch equal to ⅘ths of the rotor electrode pitch, cₑ is 1.296.

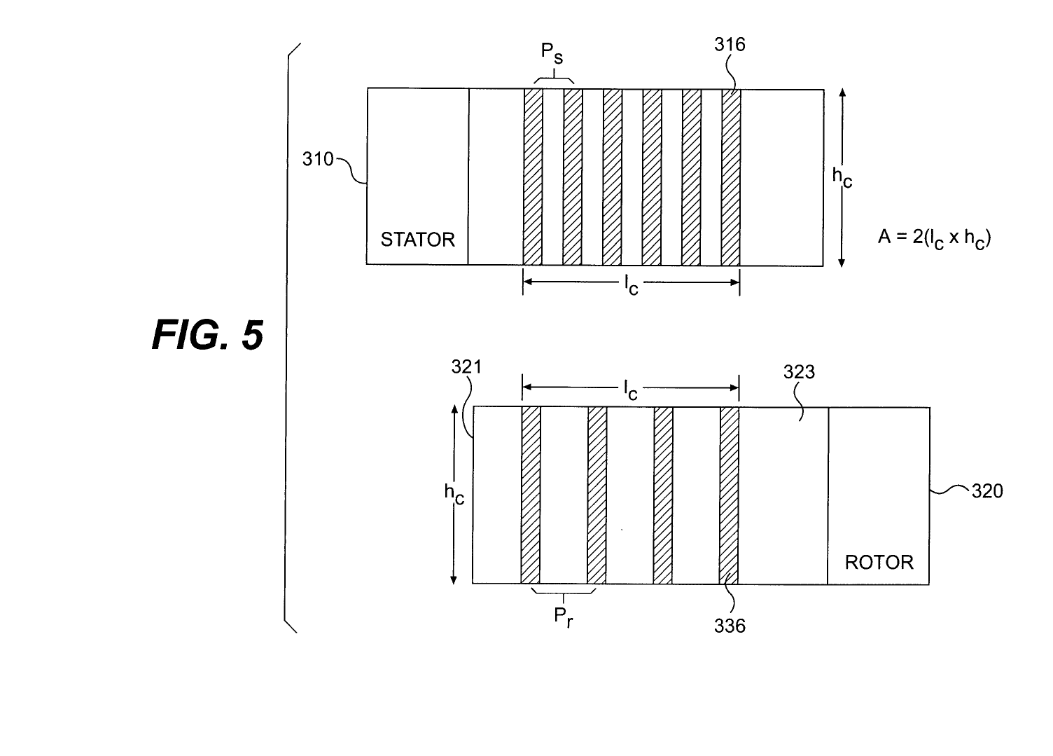

For the stepping comb drive actuator 300, the total x-direction force \acute{F}(x)_{SCD} can be determined by considering an area A over which the electrostatic forces will act. Referring now to FIG. 5, the area A is an area of overlap between the stator tooth 311 and the rotor teeth 321. That is, the area A is computed by the overlapping length of the teeth, l_{c}, multiplied by the height of the teeth h_{c}, multiplied by two, since both sides of the stator tooth 311 experience actuation forces. Including the teeth dimensions, the total x-direction force \acute{F}(x)_{SCD} per stator tooth 311 per volt squared is:

$${\hat{F} ( x )}_{SCD} = \frac{2 {c}_{e} {ɛ}_{0} {l}_{c} {h}_{c}}{{p}_{s}^{2}} \frac{sin ( \frac{π x}{{p}_{s}} )}{sinh ( \frac{π d}{{p}_{s}} )} . \qquad ( Eq . 3 )$$

By comparison, the force per volt squared from a conventional comb drive actuator tooth having a height h_{c} is:

$${F ( x )}_{CD} = \frac{- {ɛ}_{0} {h}_{c}}{d} . \qquad ( Eq . 4 )$$

Equations 3 and 4 are for equivalent cases that include the electrostatic forces arising from the potentials on both sides of the stator tooth. Furthermore, the force F(X)_{CD} per volt squared of Equation 4 is independent of the tooth/tooth overlap.

When the typical dimensions of a bulk-silicon-etched comb drive are used in the above equations (e.g., comb teeth 20 μm high, a gap d of 2 μm, an overlap of the teeth l_{f} of 200 μm, and an electrode pitch p of 2 μm, which is the case for 1 μm electrodes and 1 μm spaces), the stepping comb drive actuator 300 generates approximately 20 times more force than a conventional comb drive actuator at the same voltage. This number varies linearly with the length of the comb teeth. Also, Equation 3 shows that when the stepping comb drive actuator 300 is operated at a driving voltage V_{b} of 40 V, the actuator 300 generates ˜5 μN per tooth.

Other relationships between the spacing and voltage of the rotor and stator electrodes are described in U.S. Pat. No. 5,448,124, which is hereby incorporated by reference.

In addition to providing an increased force, the rotor 320 of the stepping comb drive actuator 300 illustrated in FIG. 2 also holds its position along the intended direction of motion (here, the x-direction) much more rigidly than will a conventional comb drive actuator. More specifically, for the above dimensions and voltages, the stepping comb drive actuator 300 holds the rotor's x-direction position with an equivalent stiffness in the x-direction of 5 N/m per tooth. For 100 teeth, therefore, the resonant frequency of the rotor 320 is the same as if an additional spring of 500 N/m were holding the rotor 320 in place. A conventional comb drive actuator, in contrast, adds no electrically-generated stiffness to the system. The added electrically generated stiffness provided by the stepping comb drive actuator 300 helpₛ maintain accurate positioning when the stepping comb drive actuator is exposed to external vibrations.

The most common failure modes of a conventional comb drive actuator and the stepping comb drive actuator drive are typically due to electrostatic force instability. A useful metric for comparing the susceptibility of a particular actuator to electrostatic force instabilities is the ratio of the maximum available force in the x-direction to the corresponding electrostatic force gradient in the y-direction. The magnitude of the electrostatic force gradient in the y-direction sets the lower limit for the required lateral stiffness of the suspension springs. For better devices, this ratio will be large. In the case of the stepping comb drive actuator 300, when the stator electrode pitch pₛ is equal to the gap d between the teeth (a common case), this ratio is simply pₛ/π, or, equivalently, d/π. For the conventional comb drive actuator, the ratio is d²/2·l_{c}. For a gap of 2 μm and a tooth overlap of 100 μm, the stepping comb drive actuator 300 is a factor of 100 better than the conventional comb drive actuator in this important metric.

In an embodiment, the rotor and stator electrodes are formed in silicon and initially are electrically isolated from each other and from the underlying substrates on which they are formed by a dielectric material such as silicon dioxide. However, no particular restrictions are made on the materials used in the rotor and the stator electrodes or the material electrically isolating the rotor and the stator electrodes.

When manufacturing the stepping comb drive actuator 300, the rotor and stator electrodes may be formed by reactive ion etching (RIE) trenches in a doped silicon-on-insulator (SOI) wafer to define both the teeth and narrow pillars of silicon arranged along the sides of the teeth. The pillars will become the electrode arrays 315, 334, and 335 in FIG. 2. The trenches are then backfilled with a silicon dioxide or other suitable insulator material to recreate a solid tooth.

Once the trenches have been formed and backfilled in the tooth, electrical contact with the isolated silicon pillars can be achieved using standard microelectronic manufacturing techniques. The actuator and mechanical suspension is then detached or “released” from the underlying substrate using other standard microelectronic manufacturing techniques. For example, the tooth can be released by etching a hole in the back of the wafer supporting the tooth or by etching away a sacrificial layer between the tooth and the wafer.

Besides the above-described technique for forming the rotor and stator electrodes, other techniques may also be used. For example, the stator and rotor electrodes may be formed by using a plating process to form conducting pillars or by depositing conducting polysilicon.

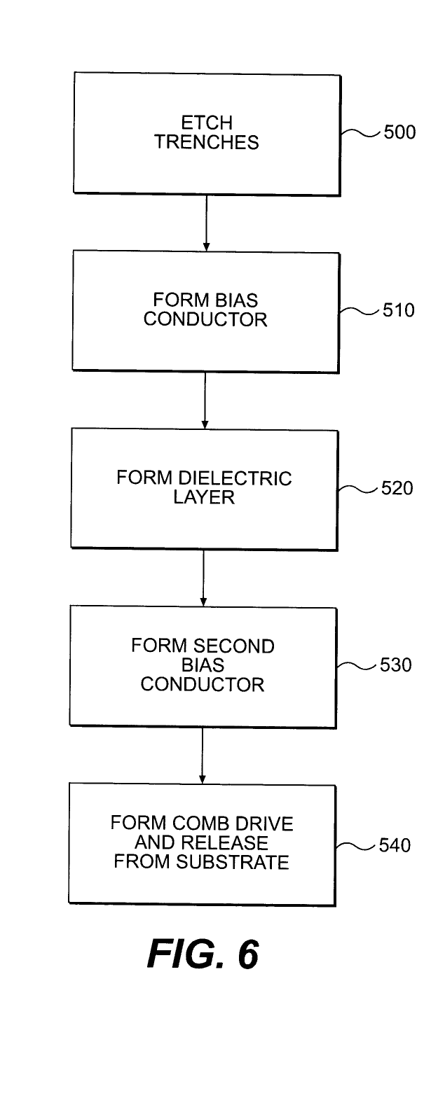

FIG. 6 is a flowchart illustrating a possible process for forming a micro-machined electrostatic stepping comb drive actuator such as the actuator 300 shown in FIG. 2. The process begins (block 500) with etching trenches defining the teeth (311, 321 in FIG. 2) and the portion of the electrode arrays (315, 334 and 335 in FIG. 2) on sides of the teeth (surfaces 312, 313, 322, 323, 326 and 327 in FIG. 2). In this process, the electrodes are formed out of the conducting wafer substrate material, typically silicon, and are at this stage vertical pillars adjacent to, but distinct from, the teeth. One technique for etching is termed deep reactive ion etching (DRIE).

Next, in block 510, a dielectric material such as silicon dioxide is deposited or grown, backfilling the trenches etched in block 500. This step isolates the teeth from the electrode arrays and from subsequent conducting layers. The dielectric material also mechanically reattaches the electrodes to the sides of the teeth. Vias are patterned and etched in the dielectric material where electrical contacts are desired.

In block 520, the first metal or other conducting layer such as polysilicon is deposited and patterned on surfaces 314, 324, and 325 in FIG. 2. The conducting layer deposited and patterned on the surfaces 314, 324, and 325 will be used to make connections between the electrodes formed in block 500 and the conductors to be added in block 540 (318 in FIG. 3A and 340 in FIG. 3D). A second dielectric layer (block 530) such as silicon nitride or silicon dioxide is then deposited to electrically isolate the electrodes from other conducting layers. Contact holes are etched in the dielectric layer in block 530 to allow the conductors to make electrical contact with the appropriate electrodes formed in block 520.

The conductors (318 in FIG. 3A and 340 in FIG. 3D) are then deposited and patterned (block 540).

A second deep reactive ion etch is used to define the final shape of the comb drive and to create the mechanical suspension for the rotor (block 550). Finally, another etch (block 560) is performed to release the finished device from the substrate. This release etch can be a plasma or wet etch (e.g. KOH) from the back of the wafer, or, if the comb drive is built on a silicon-on-insulator (SOI) wafer, an etch of the buried oxide layer of the SOI wafer from the front of the wafer. In some cases, the DRIE etch of block 550, which defines the comb drive and suspension, can be tuned to additionally undercut and release the finished structure.

The above-discussed embodiments of actuators should be considered as exemplary only, with the scope of the invention being much broader.

1. An electrostatic stepping comb drive actuator, comprising:
a first member comprising:
a first tooth and a second tooth each comprising:
a first surface, the first surface of the first tooth opposite the first surface of the second tooth;
first conductors, and
a first electrode array located on the first surfaces and comprising first electrodes in first electrode groups, the first electrodes in each of the first electrode groupₛ electrically connected to a same one of the first conductors; and
a second member comprising:
a third tooth interdigitated with the first tooth and the second tooth and movable in a direction of travel relative thereto, the third tooth comprising:
a second surface disposed opposite each of the first surfaces, second conductors, and
a second electrode array located on the second surfaces, the second electrode array comprising second electrodes in second electrode groups, the second electrodes in each second electrode group electrically connected to the same one of the second conductors.

2. The actuator of claim 1, further comprising voltage sources that impose voltage patterns on the first and the second electrodes.

3. The actuator of claim 2, wherein the voltage pattern imposed on the first electrodes is a spatially alternating voltage pattern, wherein the voltage pattern imposed on the second electrodes is a spatially substantially alternating voltage pattern.

4. The actuator of claim 2, wherein the voltage pattern imposed on the second electrodes is a spatially alternating voltage pattern, wherein the voltage pattern imposed on the first electrodes is a spatially substantially alternating voltage pattern.

5. The actuator of claim 2, wherein the voltage pattern comprises a high voltage and a low voltage.

6. The actuator of claim 5, wherein the voltage pattern comprises a third voltage intermediate between the high voltage and the low voltage.

7. The actuator of claim 1, wherein each first conductor is electrically connected to every third first electrode.

8. The actuator of claim 7, wherein each second conductor is electrically connected to every other of the second electrodes.

9. The actuator of claim 1, wherein each second conductor is electrically connected to every third second electrode.

10. The actuator of claim 9, wherein each first conductor is electrically connected to every other of the first electrodes.

11. The actuator of claim 1, wherein the first electrodes have a first pitch and the second electrodes have a second pitch different from the first pitch.

12. The actuator of claim 1, wherein the first electrode array comprises N first electrodes per unit distance and the second electrode arrays each comprise M second electrodes per unit distance, and wherein M is different from N.

13. The actuator of claim 1, further comprising a suspension that supports the first member and the second member relative to one another, and wherein the suspension is compliant in the direction of travel and is stiff in directions orthogonal to the direction of travel.

14. An electrostatic stepping comb drive actuator, comprising:
a stationary member having a tooth, the tooth comprising:
opposed surfaces, and
a first electrode array disposed on the first surfaces;
a first conductor coupled to the first electrode array;
a moveable member comprising second electrode arrays disposed on surfaces opposite the first surfaces; and
second conductors electrically connected to the second electrode arrays.

15. The actuator of claim 14, wherein the first conductor comprises N individual conductors, wherein the first electrode array comprises first electrodes, and wherein each of the N individual conductors is electrically connected to selected ones of the first electrodes.

16. The actuator of claim 15, wherein N equals three, wherein each of the N individual conductors is electrically connected to every third one of the first electrodes, and wherein the first conductor imposes a spatially substantially alternating voltage pattern on the first electrode array.

17. The actuator of claim 16, wherein the spatially substantially alternating voltage pattern comprises at least one high voltage and at least one low voltage.

18. The actuator of claim 17, wherein each of the first electrodes is set at the high voltage or the low voltage, and wherein a voltage at selected ones of the first electrodes changes from the high voltage to the low voltage and a voltage at other selected ones of the first electrodes changes from the low voltage to the high voltage.

19. The actuator of claim 15, wherein each of the second conductors comprises M individual conductors, wherein each of the second electrode arrays comprises second electrodes, and wherein each of the M individual conductors is electrically connected to selected ones of the second electrodes.

20. The actuator of claim 19, wherein each of the M individual conductors is electrically connected to every second one of the second electrodes.

21. The actuator of claim 19, wherein the first electrodes have a first pitch and the second electrodes have a second pitch different from the first pitch.

22. An electrostatic comb drive actuator, comprising:
a tooth, comprising:
opposed first surfaces, and
a first electrode array located on the first surfaces, the first electrode array comprising first electrodes;
an interconnected pair of coupled teeth, comprising:
second surfaces opposite the first surfaces, and
second electrode arrays located on the second surfaces, the second electrode arrays comprising second electrodes.

23. The electrostatic stepping comb drive actuator of claim 22, further comprising means for imparting discrete movement stepₛ to the second member.

24. The actuator of claim 22, further comprising a suspension, wherein the tooth and the second interconnected pair of coupled teeth are supported relative to one another and wherein the suspension is compliant in a first direction and is stiff in directions orthogonal to the first direction.
